(19) United States
(12) Patent Application Publication
(10) Pub. No.: US 2012/0051076 A1
(43) Pub. Date: Mar. 1, 2012

(54) BEAM CONTROL APPARATUS AND METHOD

(75) Inventors: Christian Schmidt, Paderborn (DE); Tobias Irmscher, Gutersloh (DE); Georg Florissen, Erwitte (DE); Christian Hüster, Salzkotten (DE); Stefan Krause, Versmold (DE); Carsten Wilks, Lippstadt (DE); Henrik Hesse, Paderborn (DE); Andre Hildebrandt, Schloss Holte-Stuckenbrock (DE)

(73) Assignee: Hella KGaA, Lippstadt (DE)

(21) Appl. No.: 13/218,527

(22) Filed: Aug. 26, 2011

(30) Foreign Application Priority Data
Aug. 27, 2010 (DE) 10 2010 035 636.0

(51) Int. Cl. F21V 17/02

(52) U.S. Cl. 362/512

(57) ABSTRACT

A vehicle device for switching from a high-beam light distribution to a glare-free light distribution thereby avoiding dazzling of an object; using a control device, whereas the control device shall control at least one actuating variable for setting a horizontal cut-off, and at least one actuating variable for setting a vertical cut-off of at least one headlamp.

### RELATED APPLICATIONS

This application claims priority and benefit of German Patent Application No. 10 2010 035 636.0, filed on Aug. 27, 2010, all of which are incorporated herein by reference.

### BACKGROUND OF THE INVENTION

1. Field of the Invention

The invention relates to a device for a vehicle and a procedure for switching from a high-beam light distribution to a glare-free light distribution avoiding object dazzling using a control device, whereas the control device shall control at least one actuating variable for setting a horizontal cut-off and at least one actuating variable for setting a vertical cut-off of at least one headlamp.

2. Related Art

For example, patent application DE 10 2007 038 077 A1 is known to describe a vehicle device using a control device for setting the horizontal cut-off and generating actuating variables for setting the vertical cut-off. The device published in the patent application enables switching from a high-beam light distribution to a light distribution which will avoid dazzling of oncoming traffic. The switching shall occur as soon as the distance between an oncoming vehicle which glaring should be prevented for and the vehicle equipped with the device described herein (called “own vehicle” in the following) will fall below a primary minimum value. Upon undercutting the minimum distance, the headlamp will swivel for setting a vertical cut-off and at the same time, the light range shall be reduced which in this case is the equivalent for lowering the horizontal cut-off. Upon undercutting a secondary minimum distance smaller than the primary minimum distance, a glare-free light distribution shall be activated.

### SUMMARY OF THE INVENTION

The benefit of the described device is that the switch from a high-beam light distribution with a horizontal cut-off and a large elevation angle to a glare-free light distribution, e.g. low beams or city lights, can be continuously accomplished.

The patent application does not state clearly how the lowering of the horizontal cut-off works. It is indeed suggested that the lowering depends on the distance between the own and the oncoming vehicle. An indication for this is that the lowering will be initiated upon undercutting the primary minimum distance and the glare-free light distribution will activate upon reaching the secondary minimum distance.

Controlling the horizontal cut-off depending on the distance between the object which glaring should be prevented for and the own vehicle implies an acquisition of the distance and transferring these values to the device.

This is where the invention at hand comes into play.

For this invention, the task was set to further develop the device described at the beginning in a way that the transition from high-beam light distribution to a glare-free light distribution can easily and as smoothly as possible be accomplished without the need for distance measurements. Furthermore, an appropriate procedure shall be proposed.

These tasks will be solved by a device having the features of claim 1 and a procedure having the features of claim 8.

A device structured according to the invention shall thus be structured in a way that the control device will set the at least one actuating variable for setting the horizontal cut-off of the at least one headlamp at least partially depending on an object angle of the object which glaring should be prevented for, depending on the swivel angle of the at least one headlamp and/or depending of the at least one actuating variable for setting the vertical cut-off of the at least one headlamp. A device structured according to the invention shall set the horizontal cut-off depending on a factor not correlated to the distance between the object which glaring should be prevented for and the own vehicle. Rather, parameters which are necessary for setting the vertical cut-off or will be produced upon setting the vertical cut-off shall be used.

With increasing value of the object angle, swivel angle or the actuating variable, the control device of the inventive apparatus shall, preferably in a linear way, lower the horizontal cut-off in an interval of the object angle, the swivel angle or the actuating variable, whereas swivel angle and object angle refer to the longitudinal axis of the vehicle equipped with the device and the actuating variable may correspond to such a reference to the vehicle axis.

For example, the interval of the value of the swivel angle or the object angle may extend from 4°, in particular 6° to 15°. For example, the interval of the value of the actuating variable may correspond to the value of a swivel angle from 4°, in particular 6° to 15°.

In a device structured according to the invention, the at least one actuating variable for setting the vertical cut-off of the at least one headlamp may be generated depending on the object angle of the object which glaring should be prevented.

The control device of a device structured according to the invention may contain an interface for reading the object angle of the object which glaring should be prevented for. Furthermore, it may be equipped with an interface for reading the swivel angle of a headlamp.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The figures attached hereto are taken to further explain the invention.

The following is shown:

FIG. 1 to FIG. 5 an image sequence depicting the passage of an oncoming vehicle which glaring should be prevented for, and

FIG. 6 a chart illustrating the correlation between the actuating variable for setting of the horizontal cut-off with the swivel angle of a headlamp.

### DETAILED DESCRIPTION OF THE PREFERRED EMBODIMENT

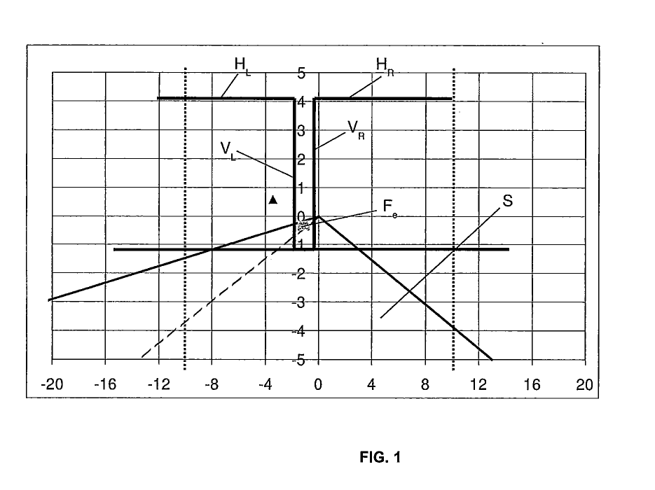

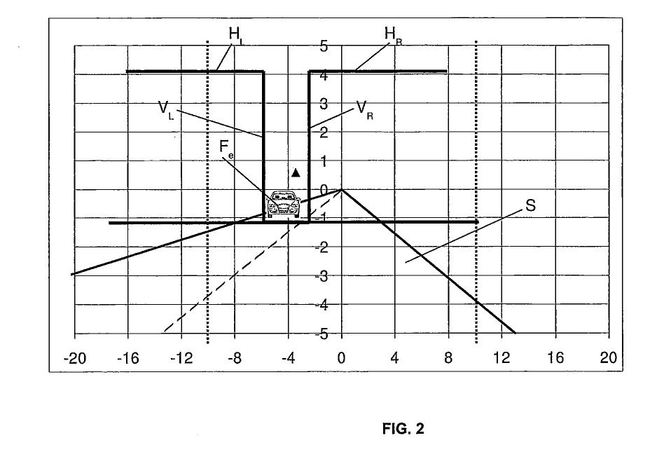

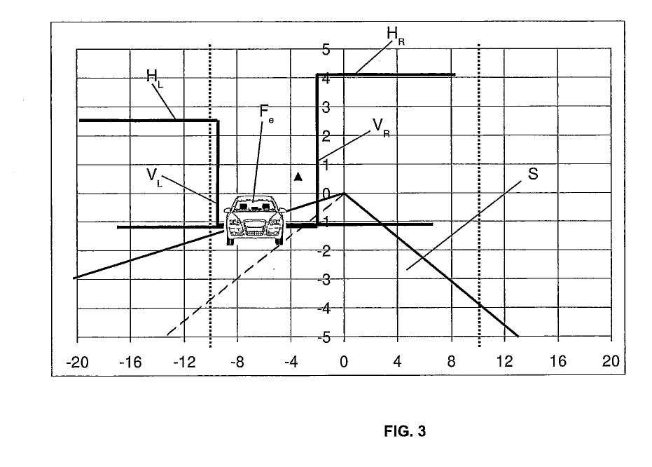

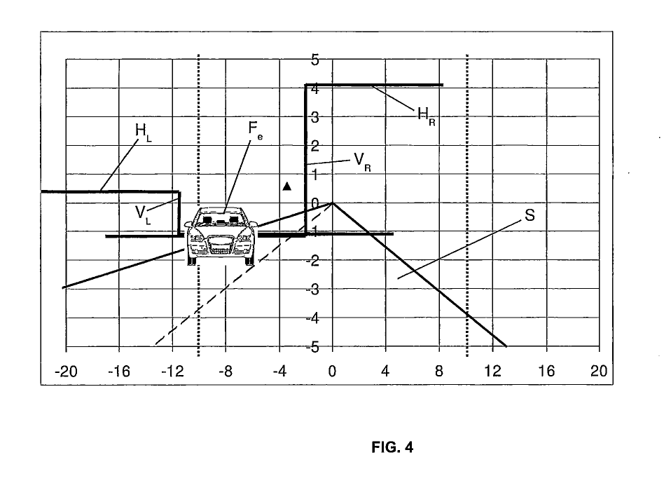

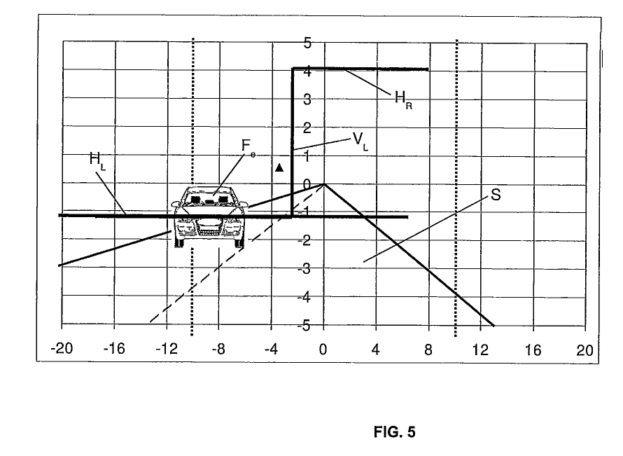

FIGS. 1 to 5 show the perspective towards the longitudinal axis of a vehicle equipped with the inventive apparatus moving on a two-lane road S. On the oncoming lane, a vehicle Fₑ moves towards the vehicle. FIG. 1 shows a situation where the oncoming vehicle Fₑ is at a considerable distance. The distance between the oncoming vehicle Fₑ to the own vehicle will then decrease according to the sequence of FIGS. 2 to 5.

The coordinate system shown in FIGS. 1 to 5 is in a plane perpendicular to the longitudinal axis of the own vehicle, and this plane runs through the point of origin of the coordinate system. The abscissa yields the object angle of the oncoming vehicle Fₑ. In the same way, the ordinate yields the elevation angle.

FIGS. 1 to 5 depict the vertical cut-offs V_{L}, V_{R} as well as the horizontal cut-off H_{L}, H_{R} of a right head lamp and a left headlamp. The headlamp swivel angles derive from the vertical cut-offs V_{L}, V_{R}.

A characteristic feature of the invention (for example, in reference to the left headlamp) is the way in which the horizontal cut-off shall be moved within the object angle interval or swivel angle interval from −6° to −15° downwards. Since object angle and swivel angle will increase as the distance of the oncoming vehicle to the own vehicle gets smaller, the elevation angle of the horizontal cut-off depicted in the sequence of FIGS. 1 to 5 will in turn decrease. The elevation angle of the horizontal cut-off will decrease in a way that a smooth transition into a light distribution similar to low beams will occur.

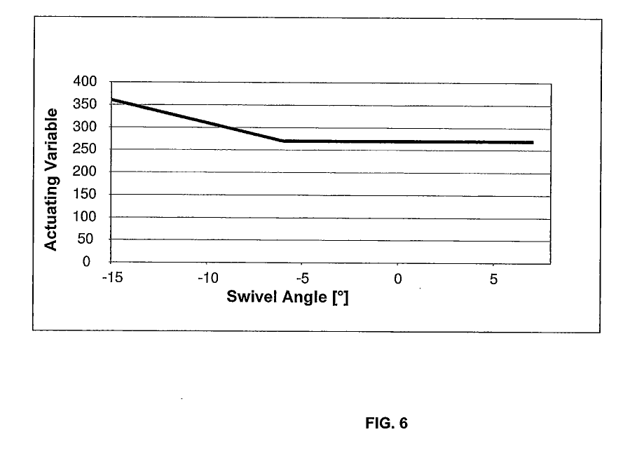

FIG. 6 shows the same correlation between the swivel angle and an actuating variable for setting the horizontal cut-off. The actuating variable will increase linearly in an interval of −6° to −15° of the swivel angle. This corresponds to a cut-off lowering. In the interval of 0° to −6° however, the actuating variable for setting the horizontal cut-off is independent from the swivel angle. The same is true for the range <−15° of the swivel angle.

Summary (FIG. 2)

The invention relates to a vehicle device for switching from a high-beam light distribution to a glare-free light distribution avoiding dazzling of an object (Fₑ), using a control device, whereas the control device shall control at least one actuating variable for setting a horizontal cut-off (H_{L}, H_{R}) and at least one actuating variable for setting a vertical cut-off (V_{L}, V_{R}) of at least one headlamp, whereas the control device can control this at least one actuating variable for setting the horizontal cut-off (H_{L}, H_{R}) of this at least one headlamp at least partially

1) depending on one object angle of the object which glaring should be prevented for (Fₑ) and/or

2) depending on a swivel angle of the at least one headlamp and/or

3) depending on the at least one actuating variable for setting the vertical cut-off (V_{L}, V_{R}) of at least one headlamp.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A vehicle device for switching from a high-beam light distribution to a glare-free light distribution to avoid glaring of an object, comprising:
a control device, the control device controlling at least one actuating variable for setting a horizontal cut-off and at least one actuating variable for setting a vertical cut-off of at least one headlamp;
the control device controls the at least one actuating variable for setting the horizontal cut-off of the at least one headlamp at least partially according to at least one of:
an object angle of the object
a swivel angle of the at least one headlamp; and
at least one actuating variable for setting the vertical cut-off of at least one headlamp

2. The device according to claim 1, wherein the control device can lower the horizontal cut-off within an interval of the object angle or the swivel angle with increasing value of the object angle or swivel angle, whereas swivel angle and object angle refer to the longitudinal axis of the vehicle to be equipped with the device.

3. The device according to claim 2, wherein the control device can lower the horizontal cut-off within an interval of the object angle or the swivel angle with increasing value of the object angle or swivel angle.

4. The device according to claim 1, wherein the interval of the value of the swivel angle or the object angle will be outside a central range in front of the vehicle, in particular outside a central range from −4° to 4.

5. The device according to one of claim 1, wherein the at least one actuating variable for setting the vertical cut-off of the at least one headlamp will be set depending on the object angle of the object for which glaring should be prevented.

6. The device according to one of the claim 1, wherein the control device has an interface for reading the object angle of the object for which glaring should be prevented.

7. The device according to one of the claim 1, wherein the control device has an interface for reading the swivel angle of the object for which glaring should be prevented.

8. The device according to one of the claim 1, wherein the interval of the object angle or the swivel angle for at least one headlamp shall be adjusted depending on the current road geometry (e.g. left-hand bend, right-hand bend).

9. A method for switching from a high-beam light distribution to a glare-free light distribution avoiding glaring of an object, comprising:
setting at least one elevation angle of a horizontal cut-off and at least one dihedral angle for setting a vertical cut-off of at least one headlamp;
setting the elevation angle of the horizontal cut-off of this at least one headlamp at least partially based on at least one of:
one object angle of the object for which glaring should be prevented;
a swivel angle of the at least one headlamp;
at least one actuating variable for setting the vertical cut-off of this at least one headlamp.
